(19) United States
(12) Patent Application Publication
(10) Pub. No.: US 2018/0273843 A1
(43) Pub. Date: Sep. 27, 2018

(54) QUANTUM DOT FILM AND METHOD OF PREPARING THE SAME

(71) Applicant: Wuhan China Star Optoelectronics Technology Co., Ltd., Wuhan, Hubei (CN)

(72) Inventor: Biao PAN, Wuhan (CN)

(73) Assignee: Wuhan China Star Optoelectronics Technology Co., Ltd., Wuhan, Hubei (CN)

(21) Appl. No.: 15/552,220

(22) PCT Filed: Jun. 20, 2017
(86) PCT No.: PCT/CN2017/089243

§ 371 Date: Aug. 18, 2017

(30) Foreign Application Priority Data
Mar. 27, 2017 (CN) 201710187909.6

(51) Int. Cl. C09K 11/88

(52) U.S. Cl. CPC C09K 11/883; B82Y 20/00

(57) ABSTRACT

The present invention relates to a liquid crystal display technical field, in particular to a quantum dot film including a support substrate and a plurality of quantum dot layers stacked on a surface of the support substrate. Each of the quantum dot layers includes a skeleton structure and a polymer distributed on a surface of the skeleton structure, and also includes a quantum dot material which is adsorbed on a surface of the polymer by an intermolecular force. The quantum dot layer structure arranged in a two-dimensional orderly of the present invention can create a stable and orderly arranged direction for the quantum dot material, so that there is non-interfering between layers, thereby improving a luminous efficiency.

### TECHNICAL FIELD

The present disclosure relates to a liquid crystal display technical field, and more specifically to a new-type quantum dot film.

### BACKGROUND ART

A liquid crystal display (LCD) mostly uses a cold cathode fluorescent lamp (CCFL) as a backlight, but with the demand of the market, a light emitting diode (LED) gradually replaces the CCFL as the backlight of the LCD due to the characteristics of its small in size, energy saving, environmental protection and the like.

A white light LED applied in a backlight module can be approached mainly in three ways: the first one is that a yellow phosphor is excited by a blue light emitted from the LED itself, the two colors light are mixed to form the white light; the second one is that an LED unit mixes three primary color LED light sources to form the white light; the third one is that a blue light LED excites red and green quantum dot films, and the three colors light are mixed to form the white light. Wherein the third approach is a widely researched approach at present, because a color gamut of a display can be increased from 70% NTSC to 110% NTSC with this approach.

In the process that the blue light LED excites the red and green quantum dot films and the three colors light are mixed to form the white light, there are two problems needed to be solved, that is, the light conversion efficiency and the stability of the quantum dot film. The light conversion efficiency of the quantum dot is very important, since it has direct impact on the dosage of the quantum dot. The approach of improving the light conversion efficiency is to improve a photoluminescence quantum yield (PLQY), this depends on the kind, the structure and the particle size of the quantum dot, and in general, the light conversion efficiency of the quantum dot is improved by adding the content of quantum dots in the prior art. However, due to a high price of the quantum dot, it may result in that the cost increases. In addition, since a problem such as a phase separation and gathering etc. easily occurs in the quantum dot itself, the photo-stability, thermo-stability and mechanical stability of the quantum dot are worse, which is also a bottleneck factor that limits the large-scale application of the quantum dot film.

Thus, with respect to the above technical problem, it is necessary to provide a two-dimensional array type of a quantum dot film.

### SUMMARY

To solve the above problem existing in the prior art, the present invention provides a quantum dot film including a support substrate and a plurality of quantum dot layers stacked on a surface of the support substrate.

Each of the quantum dot layers includes a skeleton structure and a polymer distributed on a surface of the skeleton structure, and also includes a quantum dot material which is adsorbed on the surface of the polymer by an intermolecular force.

Wherein, a number of the quantum dot layers is 1 to 50.

Wherein, a mass ratio between the quantum dot material and the polymer is 1:1˜1:20.

Wherein, the support substrate is a flexible polymer substrate, of which a particular material is selected from one of polyethylene terephthalate (PET), polyamide (PI) and polymethyl methacrylate (PMMA).

Wherein the material of the skeleton structure is selected from: [M1M2(OH)ₓ]N_{y}.4H₂O, wherein M1 and M2 are two different metals selected from Mg, Ca, Al, Ga, In, V, Cr, Mn, Fe, Co, Ni, Cu, Zn and Y; N is a negatively charged ionic group, and is particularly selected from any one of CO₃²⁻, NO₃⁻, Cl⁻, Br⁻ and SO₄²⁻; x and y are a number of atoms or groups.

Wherein, the polymer is selected from one or more of polyvinyl acetate (PVA), polymethyl methacrylate (PMMA), polystyrene (PS), acrylonitrile-butadiene-styrene (ABS), polyurethane (PU) and organosilicon polymer.

Wherein, the quantum dot material includes a red quantum dot and a green quantum dot, each being selected from any one of a compound formed of main Group II elements and main Group VI elements and a compound formed of main Group III elements and main Group V elements.

Wherein, the quantum dot material has a diameter of is 1 nm to 10 nm.

Wherein, the quantum dot film further includes a moisture blocked layer disposed at a side portion of the quantum dot layer, and the moisture blocked layer is a macromolecule polymer, an inorganic oxide or a compound of the macromolecule polymer and the inorganic oxide.

The present invention further provides a method of preparing a quantum dot film, including:

step I: soaking a pretreated support substrate in a skeleton colloid for no less than 10 min, to form a support substrate assembled with a skeleton structure;

step II: soaking the support substrate assembled with the skeleton structure in a mixture solution of the quantum dot material and the polymer for no less than 10 min, wherein a mass ratio of the quantum dot material and the polymer is 1:1˜1:20;

then the step I and the step II are repeated for n times, where n range from 1 to 50.

### Advantageous Effects

(1) The present invention can create a stable and orderly arranged direction for the quantum dot material by taking advantage of a polymer with a structure arranged in two-dimensional orderly, so that there is non-interfering between layers, thereby improving a luminous efficiency.

(2) A light emission wavelength and intensity can be controlled precisely by controlling a size of the quantum dot and value of n. A light wavelength can be controlled by controlling the size of the quantum dot, if the sizes of the quantum dots are the same, the light emission intensity will increase as the value of n increases.

(3) The quantum dot film structure obtained by assembling has very high photo-stability, thermo-stability and mechanical stability.

(4) As compared with a typical quantum dot structure being discrete distributed, the present invention can improve the luminous efficiency of the quantum dot layer within a unit thickness by using the assembled structure, so that the thickness of the required quantum dot film is reduced.

### BRIEF DESCRIPTION OF THE DRAWINGS

The above and/or other aspects, characteristics and advantages of the embodiments in the present invention will become more apparent from the following description, taken in conjunction with the accompanying drawings in which:

FIG. 1 is a structure schematic diagram of a quantum dot thin film of the present invention.

FIG. 2 is a flow chart of manufacturing the quantum dot thin film of the present invention.

### DETAILED DESCRIPTION OF EXEMPLARY EMBODIMENTS

Embodiments of the present invention will be described in detail below by referring to the accompany drawings. However, the present invention can be embodied in many different forms, and the present invention should not be construed as being limited the particular embodiments set forth herein. Rather, these embodiments are provided for explaining the principle and actual application of the present invention, thus others skilled in the art can understand various embodiments and various amendments which are suitable for specific expected applications of the present invention.

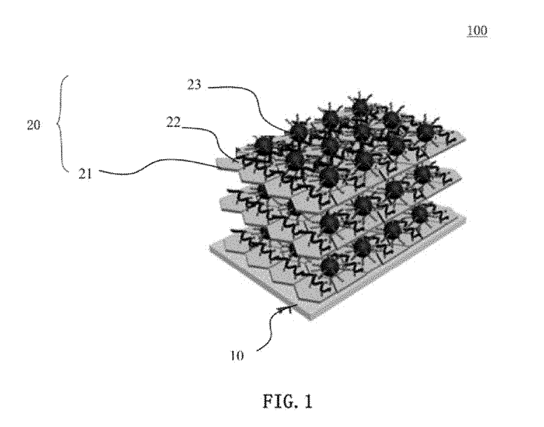

With reference to FIG. 1, the present invention provides a two-dimensional array type of a quantum dot film 100 including, from down to up, a support substrate 10 and a plurality of quantum dot layers 20 stacked on a surface of the support substrate 10.

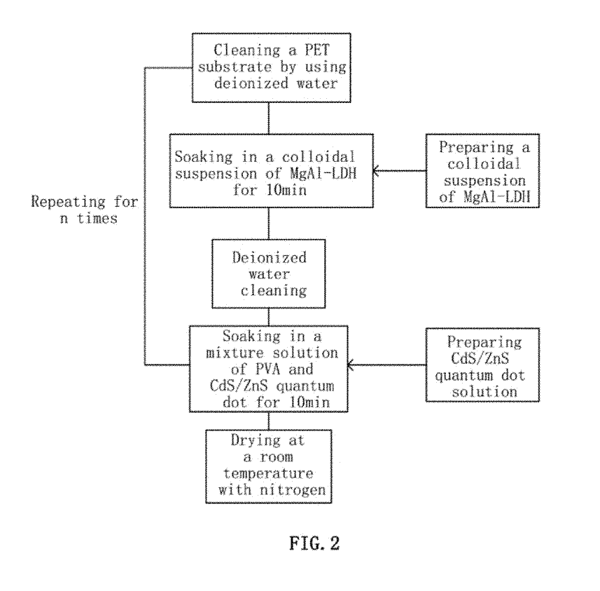

Then referring to FIG. 2, the quantum dot layers 20 may be laminated for n layers, and a value range of n is preferably 1-50. Each of the quantum dot layers 20 includes a skeleton structure 21 and a polymer 22 distributed on a surface of the skeleton structure 21, and also includes a quantum dot material 23 which is absorbed on the surface of the polymer 22 by intermolecular forces. In particular, a high molecular polymer chain of the polymer 22 stretches out on the skeleton structure 21 by a self-assembly function, to be evenly dispersed in the skeleton structure 21, and the quantum dot material 23 is absorbed on the surface of the polymer 22 by intermolecular forces, so that the quantum dot material 23 is arranged in a long-range orderly on the skeleton structure 21, i. e., arranged in a two-dimensional array type. This structure is good for improving the photoluminescence quantum yield and the stability of the quantum dot layer 20.

Wherein, the support substrate 10 is prepared by selecting a flexible polymer material, whose particular material may be, for example, one of polyethylene terephthalate (PET), polyamide (PI) and polymethyl methacrylate (PMMA).

The material of the skeleton structure 21 may be selected from layered double hydroxides (LDH) whose structural formula is [M1M2(OH)ₓ]N_{y}.4H₂O; wherein M1 and M2 are two different metals selected from Mg, Ca, Al, Ga, In, V, Cr, Mn, Fe, Co, Ni, Cu, Zn and Y; N is a negatively charged ionic group, and is particularly selected from any one of CO₃²⁻, NO₃⁻, Cl⁻, Br⁻ and SO₄²⁻; x and y are a number of atoms or groups.

In order to be successfully self-assembly with the above skeleton structure 21, the organic polymer 22 may be selected from one or more of polyvinyl acetate (PVA), polymethyl methacrylate (PMMA), polystyrene (PS), acrylonitrile-butadiene-styrene (ABS), polyurethane (PU) and organosilicon polymer.

Furthermore, the quantum dot material includes two quantum dot compounds. When the incident light of the quantum dot film is a blue light, the two quantum dot compounds are a red quantum dot and a green quantum dot in particular. Each of the red quantum dot and green quantum dot is selected from any one of a compound formed of main Group II elements and main Group VI elements and a compound formed of main Group III elements and main Group V elements. A plurality of the red quantum dot and/or the green quantum dot coat a compound of a core-shell structure formed or a doped nanocrystal. Particularly, the red quantum dot and green quantum dot may be selected from CdSe, CdTe, MgS, MgSe, MgTe, CaS, CaSe, CaTe, SrS, SrSe, SrTe, BaS, BaSe, BaTe, ZnS, ZnSe, ZnTe, CdS, GaN, GaP, GaAs, InN, InP and InAs.

Preferably, these quantum dot materials has diameters of 1 nm to 10 nm. The composed quantum dot film has a thickness within a range of 1 um to 1000 um.

In order to protect the quantum dot film or block an invasion of the moisture, a macromolecule polymer, an inorganic oxide or a composition of the macromolecule polymer and the inorganic oxide further can be used to cover a film layer on the surface of the quantum dot layer, as a protective layer or a moisture blocked layer.

A method of preparing the quantum dot film according to the present embodiment will be introduced below, the method includes:

Preparation of Materials.

(1) The support substrate is a PET substrate.

(2) The material of the skeleton structure is layered double hydroxides [Mg₆Al₂(OH)₁₇]NO₃.4H₂O. In particular, the synthetic method of [Mg₆Al₂(OH)₁₇]NO₃.4H2O is that: 40 mL aqueous solution containing Mg(NO₃)₂.6H₂O (0.002 mol) and Al(NO₃)₃.9H₂O (0.001 mol) and 40 mL aqueous solution of NaOH (0.06 mol; 40 mL) are added into colloid mill at the same time to be mixed uniformly. A rotate speed is controlled at 3000 r/min and maintained for 2 min. Then the mixture is added into a stainless autoclave, heated to 100° C. and maintained for 24 h. The obtained MgAl—NO₃-LDH is washed with water and dried at a temperature of 60° C. After redissolving in water, a skeleton colloid for soaking the support substrate can be obtained.

(3) The polymer is selected from PVA.

(4) The quantum dot material is CdSe/ZnS. Particularly, the preparing method of the quantum dot material CdSe/ZnS is that: a hexane solution (2.7×10⁻⁷ mol) of CdSe, 3 mL ODE (octadecene) and 1.0 g oleic acid is mixed, after that, being heated to 100° C. and maintained for 30 min under the protection of a nitrogen atmosphere; and the oleic acid and ODE of 0.52 mL, 0.77 mL, 1.10 mL, 1.45 mL and 2.00 mL in which Zn and S precursors are dissolved are added into the mixture at temperatures of 180° C. 200° C. 220° C. 240° C. and 250° C. respectively; at last, 0.5 mL CdSe/ZnS quantum dot solution obtained by preparing is added into chloroform, stirred for 24 h in a closed container, to volatilize the chloroform gradually, thereby obtaining the required quantum dot material.

After preparation of the above materials, as shown in FIG. 2, a preparation of the two-dimensional array type of the quantum dot film according to the present embodiment starts.

Step I: a pretreatment is conducted to the PET support substrate, that is, the PET substrate is cleaned by using deionized water.

Step II: after the cleaning, the support substrate is soaked in colloidal suspension of a skeleton colloid MgAl-LDH for 10 min, so that a layer of the skeleton structure is self-assembled on the support substrate, and then cleaning it again.

Step III: the cleaned substrate is soaked in a mixture solution of the polymer PVA and CdSe/ZnS quantum dots for 10 min, wherein a mass ratio of CdSe/ZnS and PVA is 1:4.

The above step is repeated for n times, where n is for example, 20 and n-layered two-dimensional array type of the quantum dot film can be obtained.

The finally obtained two-dimensional array type of the quantum dot film is dried at room temperature with nitrogen.

Although the present invention has been shown and described with reference to particular embodiments, it will be understood by those skilled in the art: various changes in form and details may be made therein without departing from the spirit and scope of the present invention as defined by the appended claims and its equivalents.

What is claimed is:

1. A quantum dot film, comprising a support substrate and a plurality of quantum dot layers stacked on a surface of the support substrate,
wherein each of the quantum dot layers comprises a skeleton structure and a polymer distributed on a surface of the skeleton structure, and further comprises a quantum dot material which is adsorbed on a surface of the polymer by an intermolecular force.

2. The quantum dot film of claim 1, wherein a number of the quantum dot layers is 1 to 50.

3. The quantum dot film of claim 1, wherein a mass ratio between the quantum dot material and the polymer is 1:1˜1:20.

4. The quantum dot film of claim 1, wherein the support substrate is a flexible polymer substrate, of which a material is selected from one of polyethylene terephthalate, polyamide and polymethyl methacrylate.

5. The quantum dot film of claim 1, wherein a material of the skeleton structure is selected from [M1M2(OH)ₓ]N_{y}.4H₂O,
wherein M1 and M2 are two different metals selected from Mg, Ca, Al, Ga, In, V, Cr, Mn, Fe, Co, Ni, Cu, Zn and Y,
N is a negatively charged ionic group, and is selected from any one of CO₃²⁻, NO₃⁻, Cl⁻, Br⁻ and SO₄²⁻, and
x and y are a number of atoms or groups.

6. The quantum dot film of claim 1, wherein the polymer is selected from one or more of polyvinyl acetate, polymethyl methacrylate, polystyrene, acrylonitrile-butadiene-styrene, polyurethane and organosilicon polymer.

7. The quantum dot film of claim 3, wherein the polymer is selected from one or more of polyvinyl acetate, polymethyl methacrylate, polystyrene, acrylonitrile-butadiene-styrene, polyurethane and organosilicon polymer.

8. The quantum dot film of claim 1, wherein the quantum dot material comprises a red quantum dot and a green quantum dot, each being selected from any one of a compound formed of main Group II elements and main Group VI elements and a compound formed of main Group III elements and main Group V elements.

9. The quantum dot film of claim 3, wherein the quantum dot material comprises a red quantum dot and a green quantum dot, each being selected from any one of a compound formed of main Group II elements and main Group VI elements and a compound formed of main Group III elements and main Group V elements.

10. The quantum dot film of claim 1, wherein the quantum dot material has a diameter of 1 nm to 10 nm.

11. The quantum dot film of claim 3, wherein the quantum dot material has a diameter of 1 nm to 10 nm.

12. A method of preparing a quantum dot film, comprising:
step I of soaking a pretreated support substrate in a skeleton colloid for no less than 10 min, to form a support substrate assembled with a skeleton structure;
step II of soaking the support substrate assembled with the skeleton structure in a mixture solution of a quantum dot material and a polymer for no less than 10 min, wherein a mass ratio of the quantum dot material and the polymer is 1:1˜1:20; and
repeating the step I and the step II for n times, wherein n ranges from 1 to 50.

13. The method of preparing a quantum dot film of claim 12, wherein the support substrate is a flexible polymer substrate, and whose particular material is selected from one of polyethylene terephthalate, polyamide and polymethyl methacrylate.

14. The method of preparing a quantum dot film of claim 12, wherein a material of the skeleton structure is selected from [M1M2(OH)ₓ]N_{y}.4H₂O,
where M1 and M2 are two different metals selected from Mg, Ca, Al, Ga, In, V, Cr, Mn, Fe, Co, Ni, Cu, Zn and Y,
N is a negatively charged ionic group, and is particularly selected from any one of CO₃²⁻, NO₃⁻, Cl⁻, Br⁻ and SO₄²⁻, and
x and y are the number of atoms or groups.

15. The method of preparing a quantum dot film of claim 12, wherein the polymer is selected from one or more of polyvinyl acetate, polymethyl methacrylate, polystyrene, acrylonitrile-butadiene-styrene, polyurethane and organosilicon polymer.

16. The method of preparing a quantum dot film of claim 12, wherein the quantum dot material comprises a red quantum dot and a green quantum dot, each being selected from any one of a compound formed of main Group II elements and main Group VI elements and a compound formed of main Group III elements and main Group V elements.
